(19) United States
(12) Patent Application Publication
(10) Pub. No.: US 2013/0275008 A1
(43) Pub. Date: Oct. 17, 2013

(54) Vehicular Door Control Systems

(71) Applicant: American Vehicular Sciences LLC, Frisco, TX (US)

(72) Inventor: DAVID S. BREED, MIAMI BEACH, FL (US)

(21) Appl. No.: 13/889,819

(22) Filed: May 8, 2013

Related U.S. Application Data
(63) Continuation-in-part of application No. 11/926,497, filed on Oct. 29, 2007, now abandoned.
Application No. 11/926,497 is a continuation-in-part of application No. 11/230,150, filed on Sep. 19, 2005, now Pat. No. 7,438,346.
Application No. 11/230,150 is a continuation-in-part of application No. 10/657,547, filed on Sep. 8, 2003, now abandoned.
Application No. 10/657,547 is a continuation-in-part of application No. 10/397,950, filed on Mar. 26, 2003, now Pat. No. 6,928,694.
Application No. 10/397,950 is a continuation-in-part of application No. 10/043,556, filed on Jan. 11, 2002, now Pat. No. 6,681,444.
Application No. 10/043,556 is a continuation-in-part of application No. 09/576,065, filed on May 22, 2000, now Pat. No. 6,349,448.
Application No. 09/576,065 is a continuation of application No. 09/040,206, filed on Mar. 17, 1998, now Pat. No. 6,065,185.
(60) Provisional application No. 60/409,756, filed on Sep. 11, 2002.
(60) Provisional application No. 60/040,977, filed on Mar. 17, 1997.

(51) Int. Cl. E05F 15/20

(52) U.S. Cl. CPC E05F 15/2076; E05Y 2400/66
USPC 701/49

(57) ABSTRACT

System for controlling vehicular doors includes an initiation system that initiates door opening or closing based on action by an individual that controls vehicular access, and a door control system associated with each door. At least one of the door control systems opens or closes the associated door in response to detection of an action by the individual. The initiation system may include an interrogator that detects the presence of a key fob unique to the vehicle, and the door control systems open or close the doors only when the key fob is determined to be within a threshold distance to the vehicle for a threshold duration. The interrogator may be configured to direct each door control system to open or close the associated door based on a direction of a responsive signal from the key fob such that the door closest to the key fob is controlled.

### CROSS-REFERENCE TO RELATED APPLICATIONS

This application is a continuation-in-part (CIP) of U.S. patent application Ser. No. 11/926,497 filed Oct. 29, 2007, which is a CIP of U.S. patent application Ser. No. 11/230,150 filed Sep. 19, 2005, now U.S. Pat. No. 7,438,346, which is a CIP of U.S. patent application Ser. No. 10/657,547 filed Sep. 8, 2003, now abandoned, which is:

1) a CIP of U.S. patent application Ser. No. 10/397,950 filed Mar. 26, 2003, now U.S. Pat No. 6,928,694;

2) a CIP of U.S. patent application Ser. No. 10/043,556 filed Jan. 11, 2002, now U.S. Pat. No. 6,681,444, which is a CIP of U.S. patent application Ser. No. 09/576,065 filed May 22, 2000, now U.S. Pat. No. 6,349,448, which is a continuation of U.S. patent application Ser. No. 09/040,206 filed Mar. 17, 1998, now U.S. Pat. No. 6,065,185, which claims priority under 35 U.S.C. §119(e) of U.S. provisional patent application Ser. No. 60/040,977 filed Mar. 17, 1997, now expired; and

3) claims priority under 35 U.S.C. §119(e) of U.S. provisional patent application Ser. No. 60/409,756 filed Sep. 11, 2002, now expired.

All of the above-mentioned applications are incorporated by reference herein in their entirety.

### FIELD OF THE INVENTION

The present invention relates generally to door actuation systems, mechanisms and method for vehicles. The present invention relates more particularly to systems that control access to vehicular doors, namely, opening and closing of the doors, based on action by an individual seeking to enter or exit the vehicle.

### BACKGROUND OF THE INVENTION

U.S. Pat. No. 6,928,694 (Breed et al.) discloses a door check device for a vehicle door that is movable from a closed position in a door frame to a plurality of different open positions and capable of being held in the open positions. The door check mechanism includes a strip connected to the door or door frame and a braking mechanism connected to the other of the door or door frame to provide relative movement between the strip and braking mechanism when the door is moved relative to the door frame. The braking mechanism engages with the strip at several locations and prevents movement of the strip when the braking mechanism engages therewith. The vehicle also includes an electrical system, e.g., a motor or solenoid, coupled to the braking mechanism to disengage it from the strip to permit relative movement between the strip and braking mechanism and thus movement of the door relative to the door frame. Other mechanisms for controlling movement of a door are disclosed in U.S. Pat. Nos. 6,065,185 (Breed et al.), 6,349,448 (Breed et al.), and 6,681,444 (Breed et al.).

### OBJECTS AND SUMMARY OF THE INVENTION

A system for controlling one or more vehicular doors in accordance with the invention includes an initiation system that initiates opening or closing of the doors based on action by an individual that controls access to the vehicle, and a door control system associated with each door and coupled to the initiation system. At least one of the door control systems opens or closes the associated door in response to detection of an action by the individual.

In one embodiment, the initiation system includes an interrogator that detects the presence of a key fob unique to the vehicle, in which case, the door control systems are configured to open or close the doors only when the key fob is determined to be within a first threshold distance to the vehicle for a threshold duration. The interrogator may be configured to direct each door control system to open or close the associated door based on a direction of a responsive signal from the key fob such that the door closest to the key fob is opened or closed. Also, opening of a door via one of the door control systems may be delayed after initial detection of the presence of the key fob until the key fob is within a second threshold distance of the vehicle.

The initiation system may include a detection system that detects of the presence of a person or part thereof in a door access area associated with each door, i.e., the door access area being that portion of space around the vehicle in which the person will be situated or will place a part of their body to indicate they want the associated door to open. The detection system may be configured to detect and interpret gestures indicative of a desire to open or close a specific one of the doors of the vehicle, e.g., a pointing finger, such that the door control systems associated with the specific door is directed to open or close the door based on the gesture interpreted by the detection system, e.g., the individual points to the door they want to open or close. The initiation system may be configured to perform biometric recognition a person in the door access area and initiate opening or closing of the at least one door via the door control systems only when the person is biometrically recognized. In this latter case, the initiation system may also include an interrogator that detects the presence of a key fob unique to the vehicle such that the initiation system initiates opening or closing of the at least one door via the door control systems only when the person is biometrically recognized and the key fob is determined to be within a first threshold distance to the vehicle for a threshold duration.

The initiation system may also include a button accessible to an occupant of the vehicle. In this case, an interlock is optionally provided to prevent the button from causing the door control system to open or close the associated door unless a vehicle transmission is in park or a vehicle ignition is in an off position.

The initiation system may also include a pivotable steering wheel, with pivotal movement of the steering wheel being correlated to opening or closing of a driver's door of the vehicle by the door control system associated with the driver's door. In this case, the initiation system includes a sensing system that detects angular position or movement of the steering wheel, upward angular movement above a threshold causing opening of the driver's door and downward angular movement above a threshold causing closing of the door. Again, an interlock is optionally provided to prevent pivotal movement of the steering wheel from causing the door control system to open or close the associated door unless a vehicle transmission is in park or a vehicle ignition is in an off position.

In any of the above-described embodiments, an obstacle detection system, that detects obstacles in an opening or closing path of each door and stops opening or closing movement of the door when an obstacle is detected, may be provided.

### BRIEF DESCRIPTION OF THE DRAWINGS

The following drawings are illustrative of embodiments of the invention and are not meant to limit the scope of the invention as encompassed by the claims.

FIG. 1 is a view of a vehicle with an automatic door opening capability;

FIG. 2 is a view of the front of the passenger compartment showing a door access control mechanism;

FIG. 3 is a view showing a door of a vehicle including a button for opening the door;

FIG. 4A is a view showing door control integrated into a steering wheel; and

FIG. 4B is a view of the front of the passenger compartment showing the door control integrated into the steering wheel.

### DETAILED DESCRIPTION OF PREFERRED EMBODIMENTS

Referring to the accompanying drawings wherein like reference numerals refer to the same or corresponding parts throughout the several views, FIG. 1 shows an embodiment providing a key fob-initiated control of a door of a vehicle.

A key fob 10 is a small portable device that enables access to a vehicle 12. The key fob 10 usually includes a radio frequency identification (RFID) device (not shown) that interacts with an interrogator 14 on the vehicle 12 to cause the door(s) 16 of the vehicle 12 to unlock based on the duration that the key fob 10 is within a threshold distance of the vehicle 12 or upon the depression of a button on the key fob 10. Thus, the door(s) 16 of the vehicle 12 would automatically unlock when a person with the proper RFID key fob 10 is near the vehicle 12 for the designated time period or depresses the button. The interrogator 14 is thus coupled to a door unlocking mechanism (not shown) to direct the door unlocking mechanism to unlock the door(s) 16 upon receiving a signal generated by the RFID device on the key fob 10.

In accordance with the invention, a door opening system or mechanism 18 is coupled to the interrogator 14 and associated with the door 16. As such, when the interrogator 14 detects the presence of the key fob 10 for the threshold duration within the threshold distance, the door opening mechanism 18 is actuated to open the door 16. The threshold duration and threshold distance required to initiate opening of the door 16 may be different than those required to unlock the door 16, i.e., a higher duration and shorter distance. Thus, there may be different criteria to unlock the door 16 than to open the door 16. Similarly, the criteria to close the door 16 may be different than those to lock the door 16, e.g., the door will be closed when the occupant initially exits the vehicle but locked only a few seconds later to allow the person to “change their mind” and re-enter the vehicle without it having to be locked and then unlocked.

The connection between the interrogator 14 and the door opening mechanism 18 may be a wired or wireless connection, or combination thereof. Although only one door 16 of the vehicle 12 is shown, a door opening mechanism 18 may be associated with each door 16, or it is possible to associate a door opening mechanism 18 with a plurality of doors 16.

The interrogator 14 may be configured to determine the direction of the responsive signal from the key fob 10 and open the door 16 closest to the key fob 10. Or the interrogator 14 may be configured to unlock those doors closest to the key fob 10 and then as the key fob 10 gets closer to the vehicle, open the closest, unlocked door to the key fob 10.

In another configuration of the invention, the person possessing the key fob 10 can depress a button on the key fob 10 and initiate both the unlocking and the opening of the door 16. Current systems use the key fob 10 to unlock a vehicle door but not to also initiate the opening of the door.

Since the currently available key fobs can operate from a significant distance, in some cases, a distance measuring system can be provided as is known in the art to delay the opening of the door 16 until the key fob 10 is within some design distance, such as 5-10 feet, from the vehicle door. This also will prevent the opening of multiple doors. Thus, a processor on the vehicle would be configured to respond to depression of the button on the key fob 10 by authorizing unlocking of the door 16, monitoring a distance between the key fob 10 on one hand and the vehicle 12 in general or the door 16 specifically on the other, and then open the door 16 only after the key fob 10 is within a threshold distance to the vehicle 12 or door 16.

In each of the cases described herein, there can also be provided a system or mechanism that detects people or objects that are in the path of the opening door and to stop such opening if the door is about to impact the person or object. Additional details of a door opening control mechanism are found in the parent '497 application, incorporated by reference herein.

The key fob 10 is an example of a door opening initiation system or mechanism which is capable of causing opening of the vehicular door(s) 16 when the mechanism is at a threshold distance from the vehicle 12 for a specific duration of time or the button on the key fob 10 is depressed. Other systems and mechanisms are also envisioned and considered within the scope and spirit of the invention. One such alternative system or mechanism is a detection system or mechanism 20 that detects of the presence of a person or part thereof in a door access area 22 and provides an indication of the detection of the person or part thereof to a processor 24 on the vehicle 12. The door access area 22 is that portion of space around the vehicle 12 in which the person will be situated or will place a part of their body to indicate they want an associated door 16 to open.

Additionally or alternatively, detection mechanism 20 may be configured to detect and interpret gestures indicative of a desire to open or close the door 16. In this case, the person with the key fob 10 may be close to the vehicle 12 and indicate with a gesture, e.g., pointing their finger, that they want the door 16 to open and the detection mechanism 20 is able to recognize this gesture, e.g., through training, and direct opening of the door 16. In addition to or instead of gestures, the detection mechanism 20 may be configured to perform face and/or other biometric recognition (including voice print, palm print, fingerprint, etc.). This recognition coupled with, or independent of, the presence of the key fob 10 will cause opening or closing of the door 16.

In a preferred embodiment, the processor 24 does not open the door(s) 16 upon detection of a person or part thereof in the associated door access area 22, but rather also considers whether the person is carrying the key fob 10 and/or is identified through a biometric ID system on the vehicle. Any biometric identification systems and techniques may be used in the invention.

The detection mechanism 20 may operate based on reception of waves, e.g., electromagnetic waves or ultrasonic waves that may be transmitted by the appropriate transmitter included in the detection mechanism 20. The detection mechanism 20 may be used in combination with the interrogator 14, i.e., both installed on the vehicle 12 to enable use of the key fob 10 alone to open the door 16 or presence in the door access area 22 as detected by detection mechanism 20 along with the key fob 10 being required to open the door 16.

One manner in which opening of one or more of the vehicular doors 16 is controlled based on the detection of a person or part thereof in the door access area 22 associated with each door 16 is as follows. For example, for each of the side doors of the vehicle as shown in FIG. 1, or the sliding door of a minivan, the door access area 22 may be that area adjacent the door extending to about 5-10 feet away. The processor 24 monitors the door access areas 22 to detect the presence of the person or part thereof, and also simultaneously, monitors response to transmissions from the interrogator 14 to detect the presence of the specific key fob 10 that accesses the vehicle 12. When the processor 24 detects the presence of the person or part thereof in one of the door access areas 22 and a response to transmission from the interrogator 14 is received, it opens the door 16 associated with that door access area 22, unlocking the door if necessary prior to opening it.

Although FIG. 1 illustrates a sliding front door and sliding side doors are discussed above, the invention is equally applicable to common hinged doors which rotate from a pillar, such as the A-pillar or B-pillar, of a road vehicle. Also, closing of the doors can be controlled in the same manner as opening of the doors.

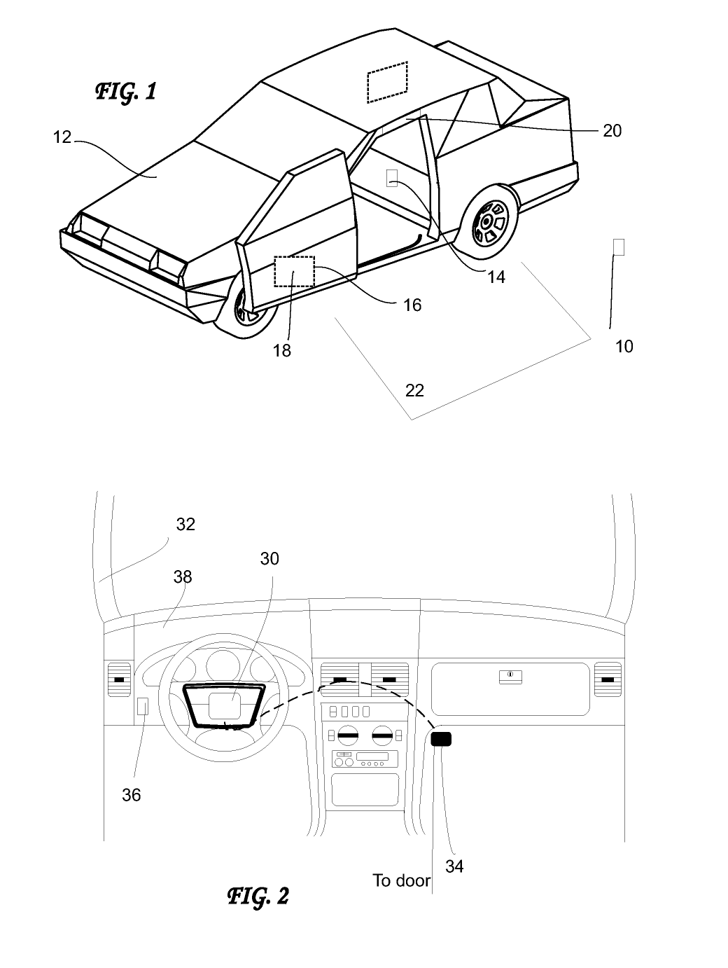

Referring now to FIG. 2, this embodiment of the invention is particularly beneficial for people that may have difficulty opening a door when seated inside the vehicle. To facilitate opening the door without grabbing the handle, a responsive system or mechanism 30 is arranged on a structure of the vehicle 32. The responsive mechanism 30 is configured to monitor sounds in the vehicle 32, such as an oral enunciation, to detect a command to open the door (not shown).

Additionally or alternatively, the responsive mechanism 30 is configured to monitor the space in the passenger compartment of the vehicle, by using one or more cameras or optical imagers for example, for a gesture by an occupant that is indicative of a desire to open the door. In this case, it is possible to include a training program, such as a neural network, in the responsive mechanism 30 so that the occupant can perform a gesture once, train the responsive mechanism 30 to recognize that gesture as being indicative of a desire to open a door, and then operatively open the door whenever that same gesture is detected. Pattern recognition may be used to improve the recognition of the gesture by the recognition mechanism 30. Alternatively, the system can be configured or pre-trained to recognize a class of pointing gestures, for example, thus eliminating the need for on-vehicle training.

A processor 34 is coupled to the responsive mechanism 30 and to a door opening mechanism and directs the door access control mechanism to open the door. The door access control mechanism may also be controlled by the processor to close the door. Such a door access control mechanism may be any conventional structure known to those skilled in the art.

This embodiment may be particular useful for older people with limited manual dexterity to open side doors of a vehicle. The recognition system may be trained to recognize a gesture that is as simple as a finger pointing to the door, so that the people with limited manual dexterity could easily cause the door to open. Similarly, the recognition mechanism may be configured to recognize a finger pointing in the opposite direction, away from the door, which may be associated with a desire to close an open door. Opening or closing of the door would therefore depend on the direction in which the occupant's finger is pointing relative to the door. Toward the door would be associated with an opening action and away from the door would be associated with a closing action. Alternately, the direction of the pointing of the finger can indicate which door is to be operated and it can be then opened if it is closed, and closed when it is opened. This will permit a driver to signal to open and close the passenger door, or a backseat door, to aid others in entering and leaving the vehicle. In addition to older people, this arrangement can be useful for aiding children or people carrying packages.

The systems described herein are also useful for situations where inclement weather has made manual opening of vehicle doors especially from outside of the vehicle otherwise difficult.

Referring again to FIG. 2, another way to enable an occupant of a vehicle to open or close a door is to provide a depressible or actuatable button 36 on the dashboard or on the instrument panel 38. The placement of the button 36 can be dependent on the arrangement of instruments and displays on the instrument panel 38, but in a preferred embodiment, the button 36 is placed near where the ignition keys are inserted since the driver must have the ability to insert or remove the ignition key and therefore could certainly push button 36 that is located nearby.

For those vehicles that use a button to start the vehicle, a second button can be placed nearby for opening or closing the door(s). In fact, multiple additional buttons can be used, for example, one for the left door and one for the right door, and even others for each rear door and hatchback, to permit the driver to open a door for a companion. Depression of any of the buttons causes a signal to be sent to the door access control mechanism that is configured to unlock and open a door associated with that button, possibly through conventional hardware such as a processor, a wire bus, and the like.

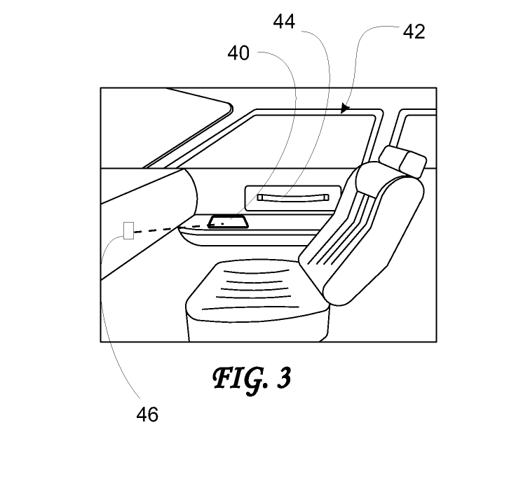

In another embodiment using a button, a button 40 is situated on the door 42 itself and can be used in addition to the door handle 44 to permit, for example, an older person to open the door 42 (see FIG. 3) by using the button 40 in place of the door handle. This button 40 must be appropriately placed such that the older person cannot open the door 42 accidentally.

An interlock 46 can be provided to prevent the button 40, or any of the door opening mechanisms described herein, from functioning unless the transmission is in park or the ignition is in the off position. This interlock 46 is thus coupled to the vehicle ignition system (not shown), as represented by the dotted line in FIG. 3, and unless the ignition is in the off position, or the transmission in park, it does not allow opening of the door 42 upon depression of the button 40.

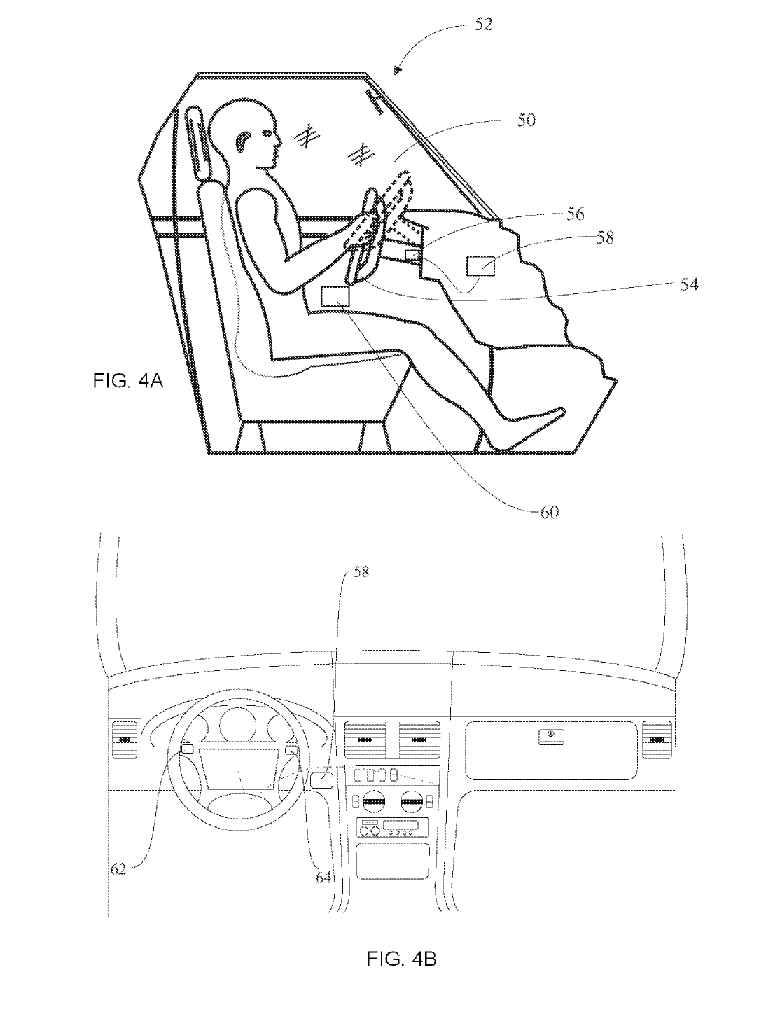

Referring now to FIGS. 4A and 4B, yet another way to open a driver's door 50 of a vehicle 52 would be to configure the steering wheel 54 to be pivotable and cause the door 50 to be opened upon upward pivoting of the steering wheel 54 above a threshold. In a similar manner, downward pivoting of the steering wheel 54 above a threshold would cause the door 50 to close.

To convert the pivotal movement of the steering wheel 54 into opening or closing movement of the door 50, a sensing system or mechanism 56 is provided to detect the angular position or movement of the steering wheel 54. When an upward angular movement above a threshold is detected, a processor 58 coupled to the sensing mechanism 56 directs a door access control system or mechanism 60 to open the door 50. When a downward angular movement above a threshold is detected, the processor 58 directs the door access control mechanism 60 to close the door 50. Again, these actions can be locked out when the vehicle ignition is on, or the transmission is not in the park position.

Instead of providing the sensing mechanism 56 to monitor for pivotal movement of the steering wheel 54, it may be configured to monitor depression of pressure-sensitive areas of the steering wheel 54 itself. One pressure sensitive area 62 may be provided on an inner circumferential area of the steering wheel 54 and another pressure sensitive area 64 on the outer circumferential area of the steering wheel 54. When pressure is detected above a threshold on the pressure sensitive area 62, the processor 58 directs the door access control mechanism 60 to open the door 50. When pressure is detected on the pressure sensitive area 64 above a threshold, the processor 58 directs the door access control mechanism 60 to close the door 50. Alternately, a single pressure sensitive area can be provided and the door opened when it is close or closed when it is opened upon the detection of pressure in the pressure sensitive area 62 or 64.

In these embodiments, pivotal movement of the steering wheel 54 or pressure on the pressure sensitive areas 62, 64 does not cause movement of the door 50 unless the vehicle is off, or the vehicle in park. As described above, an interlock may be provided to prevent movement of the door unless either of these two conditions are satisfied. The interlock is coupled to the vehicle ignition system, the sensing mechanism 56 and the pressure sensitive areas 62, 64 and conditions opening or closing of the door 50 on the determined status of the vehicle ignition.

Movement of the steering wheel 54 or depression of a pressure-sensitive area 62, 64 thereon is an easy function for the driver to perform to effect opening or closing of the door 50, Another advantage is that it provides more space for the driver to enter or exit the vehicle since the steering wheel 54 is in an upwardly pivoted position.

Preferred embodiments of the invention are described above and unless specifically noted, it is the applicant's intention that the words and phrases in the specification and claims be given the ordinary and accustomed meaning to those of ordinary skill in the applicable art(s). If applicant intends any other meaning, he will specifically state he is applying a special meaning to a word or phrase.

Likewise, applicant's use of the word “function” here is not intended to indicate that the applicant seeks to invoke the special provisions of 35 U.S.C. §112, sixth paragraph, to define his invention. To the contrary, if applicant wishes to invoke the provisions of 35 U.S.C. §112, sixth paragraph, to define his invention, he will specifically set forth in the claims the phrases “means for” or “step for” and a function, without also reciting in that phrase any structure, material or act in support of the function. Moreover, even if applicant invokes the provisions of 35 U.S.C. §112, sixth paragraph, to define his invention, it is the applicant's intention that his inventions not be limited to the specific structure, material or acts that are described in preferred embodiments herein. Rather, if applicant claims his inventions by specifically invoking the provisions of 35 U.S.C. §112, sixth paragraph, it is nonetheless his intention to cover and include any and all structure, materials or acts that perform the claimed function, along with any and all known or later developed equivalent structures, materials or acts for performing the claimed function.

Although several preferred embodiments are illustrated and described above, this invention is not limited to the above embodiments and should be determined by the following claims. Indeed, it will be understood that numerous modifications and substitution can be made to the above-described embodiments without deviating from the scope and spirit of the invention.

Accordingly, the above-described embodiments are intended for the purpose of illustration and not as limitation.

1. A system for controlling at least one door of a vehicle, comprising:
an initiation system that initiates opening or closing of the at least one door based on action by an individual that controls access to the vehicle; and
a door control system associated with each door of the vehicle and coupled to said initiation system, at least one of said door control systems opening or closing an associated one of the doors in response to detection of an action by the individual.

2. The system of claim 1, wherein said initiation system comprises an interrogator that detects the presence of a key fob unique to the vehicle, said door control systems being configured to open or close the doors only when the key fob is determined to be within a first threshold distance to the vehicle for a threshold duration.

3. The system of claim 2, wherein said interrogator is configured to direct the at least one of said door control system to open or close the associated door based on a direction of a responsive signal from the key fob such that the door closest to the key fob is opened or closed.

4. The system of claim 2, wherein opening of a door via one of said door control systems is delayed after initial detection of the presence of the key fob until the key fob is within a second threshold distance of the vehicle.

5. The system of claim 1, further comprising an obstacle detection system that detects obstacles in an opening or closing path of each door and stops opening or closing movement of the door when an obstacle is detected.

6. The system of claim 1, wherein said initiation system comprises a detection system that detects of the presence of a person or part thereof in a door access area associated with each door, the door access area being that portion of space around the vehicle in which the person will be situated or will place a part of their body to indicate they want the associated door to open.

7. The system of claim 6, wherein said detection system is configured to detect and interpret gestures indicative of a desire to open or close a specific one of the doors of the vehicle, such that said door control systems associated with the specific door is directed to open or close the door based on the gesture interpreted by said detection system.

8. The system of claim 6, wherein said initiation system is configured to perform biometric recognition a person in the door access area and initiate opening or closing of the at least one door via said door control systems only when the person is biometrically recognized.

9. The system of claim 8, wherein said initiation system further comprises an interrogator that detects the presence of a key fob unique to the vehicle such that said initiation system initiates opening or closing of the at least one door via said door control systems only when the person is biometrically recognized and the key fob is determined to be within a first threshold distance to the vehicle for a threshold duration.

10. The system of claim 6, wherein said detection system is configured to receive waves and convert reception of waves into an indication of the presence of a person or part thereof in the door access area.

11. The system of claim 1, wherein said initiation system comprises a responsive system that monitors sounds originating within a passenger compartment of the vehicle and determines when sound indicative of a command to open or close a door of the vehicle is present.

12. The system of claim 1, wherein said initiation system comprises a responsive system that monitors gestures by an occupant of a passenger compartment of the vehicle and determines when a gesture indicative of a desire to open or close a door of the vehicle is present.

13. The system of claim 12, wherein said responsive system is configured to apply pattern recognition to recognize gestures by the occupant.

14. The system of claim 12, wherein said responsive system is configured to determine which one of the doors is to be opened or closed based on the recognized gesture.

15. The system of claim 1, wherein said initiation system comprises a button accessible to an occupant of the vehicle.

16. The system of claim 15, further comprising an interlock that prevent said button from causing said door control system to open or close the associated door unless a vehicle transmission is in park or a vehicle ignition is in an off position.

17. The system of claim 1, wherein said initiation system comprises a pivotable steering wheel and pivotal movement of the steering wheel is correlated to opening or closing of a driver's door of the vehicle by said door control system associated with the driver's door.

18. The system of claim 17, wherein said initiation system comprises a sensing system that detects angular position or movement of the steering wheel, upward angular movement above a threshold causing opening of the driver's door and downward angular movement above a threshold causing closing of the door.

19. The system of claim 18, further comprising an interlock that prevent pivotal movement of the steering wheel from causing said door control system to open or close the driver's door unless a vehicle transmission is in park or a vehicle ignition is in an off position.

20. The system of claim 1, wherein said initiation system comprises at least one pressure-sensitive area on a steering wheel and depression of the at least one pressure-sensitive area is correlated to opening or closing of a driver's door of the vehicle by said door control system associated with the driver's door.
